(19) United States
(12) Patent Application Publication
(10) Pub. No.: US 2017/0116569 A1
(43) Pub. Date: Apr. 27, 2017

(54) REUSABLE INSULATED GIFT CONTAINER INFORMATION TRACKING SYSTEM

(71) Applicant: Kathryn Cloud, Chandler, AZ (US)

(72) Inventor: Kathryn Cloud, Chandler, AZ (US)

(21) Appl. No.: 14/921,884

(22) Filed: Oct. 23, 2015

(51) Int. Cl. G06Q 10/08

(52) U.S. Cl. CPC G06Q 10/0833

(57) ABSTRACT

A method for maintaining information about a reusable, insulated gift bag container transferred across multiple users include providing an information maintenance system comprising a reusable, insulated gift bag container, a computing device, a communication network, and a server. Unique tracking indicia of the reusable, insulated gift bag container is tracked via a computing device. An original purchaser purchases the reusable, insulated gift bag container from a website or store and registers under the unique tracking indicia through the communication network, and the server stores information. The original purchaser transfers the reusable, insulated gift bag container to another user who registers new location information and the tracking indicia. The original registrant is notified or retrieves the new location information of the reusable, insulated gift bag container through entering the tracking indicia to the communication network. The reusable gift container is re-gifted repeatedly for the lifetime of the reusable, insulated gift bag container.

### BACKGROUND

Conventionally, many people wrap gifted articles in disposable gift bags or containers. Globally, a large amount of these gift containers are typically made of, but not limited to paper, plastic, etc. These types of gift containers are temporary and disregarded once opened, as they are not made of resilient materials and tend to tear and lose their shape and attractiveness upon first use. Because they cannot be reused, these disposable gift containers are eventually destroyed rather than being re-purposed as a gift container. This is a tedious process and contributes to accumulation of waste worldwide. Therefore, there arises a need for reusable, insulated gift bag containers made of durable materials that maintain appearance and functionality when transferred from one person to another person. Thus, the recipient sees the insulated, reusable gift bag container as a gift, and not a disposable vehicle for the gift inside.

Further, current gift bags do not provide for the ability to log or track any information regarding the occasion, the giver or the recipient, for example, name, email, location, sentiments, pictures recording the event, where it had traveled, or if it had previous owners. The containers are not enabled with a dedicated tracking system to provide a user with clear information regarding the history of the container. Further, there lacks the additional option for attaching a complimentary and collectible toy, plush figure or bottle stopper that can accommodate for example, but not limited to wine, spirits, champagne, etc., into the bag that signifies the specific occasion or sentiment (for example, a collectible toy, plush figure or bottle stopper) to compliment the gift.

Hence, there is a long felt, but unresolved desire for a method where gift givers can track the movement of and receive updates on the reusable, insulated gift bag container they gifted to transfer across a plurality of users. Previous and current owners would have shared ability to add information and access to the whereabouts of the reusable, insulated gift bag container after they have re-gifted it.

### SUMMARY OF THE INVENTION

The method disclosed herein addresses the above stated need for tracking and maintaining information about a reusable, insulated gift bag container that has been gifted or transferred across multiple users. The method for maintaining the history of the reusable, insulated gift bag container that has been transferred across multiple users would include an information maintenance system, a computing device, a communication network, and a server. Unique tracking indicia is inscribed on the reusable, insulated gift bag container, which is tracked via the computing device controlled by at least one processor. To launch, a first user purchases the reusable, insulated gift bag container from a website or a store, and registers through the website using the unique tracking indicia to the communication network. Once the reusable, insulated gift bag container has been re-gifted or transferred to the next user or recipient, the new user can register and add information onto the communication network using the same unique tracking indicia. This process can be replicated for the life of the reusable, insulated gift bag.

The server can store information per each tracking indicia, for example, the location, notes, pictures, and events for each subsequent user of the reusable, insulated gift bag container. The first user and subsequent users or owners of the reusable, insulated gift bag container have the option of registering with their name or alias and a valid email address or phone number, for example, to receive updates and membership reward points. All tracking information for a particular indicia tracking number will be shared with each of the registrants under that same number via email or text.

Second and subsequent registrants enter their information using the unique tracking indicia serial number which is secured on the reusable, insulated gift bag container, onto the communication network through the website. A notice of the new user and location of the gift container is sent to all the users registered with the same indicia tracking number. Points are earned for each user that registered with the same tracking indicia number. In an embodiment, the reusable, insulated gift bag container further comprises a pocket containing a complimentary notebook for personalized messages. In an embodiment, the method further comprises attaching an optional adornment, for example, toy, plush figure or bottle stopper, which is sold separately and custom made to both compliment the reusable, insulated gift bag container and to fit an item such as a bottle inside. The toy, plush figures or bottle stoppers may or may not have tracking indicia, and can be re-gifted, or kept as a keepsake or collectible. In an embodiment, registered users earn membership points for each purchase and for each a new registrant with the same tracking indicia. Membership points, which can be accumulated for membership rewards.

### BRIEF DESCRIPTION OF THE DRAWINGS

FIG. 1 exemplarily illustrates a schematic diagram of the reusable, insulated gift bag container information maintenance system.

FIG. 2 exemplarily illustrates for maintaining information about a reusable, insulated gift bag container that's transferred across multiple users.

FIGS. 3A-3B exemplarily illustrates a schematic diagram showing a working example of an embodiment of the reusable, insulated gift bag container information maintenance system.

### DETAILED DESCRIPTION OF THE INVENTION

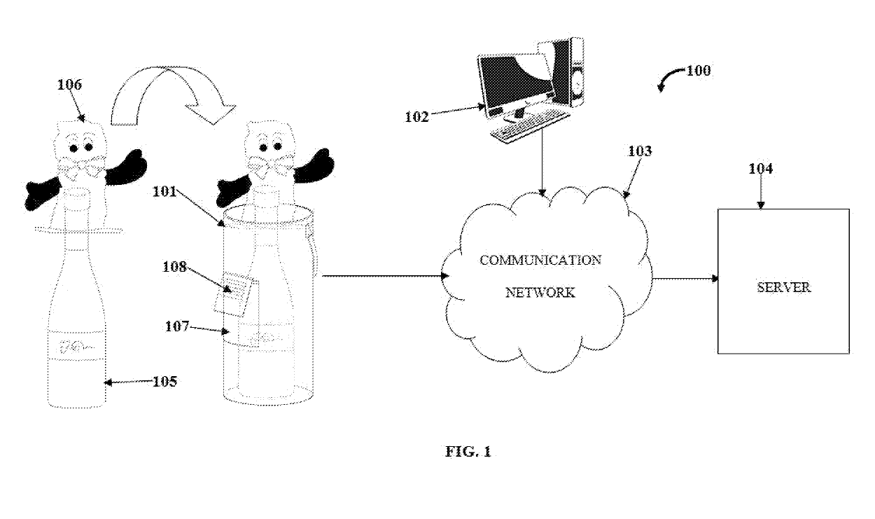

FIG. 1 exemplarily illustrates a schematic diagram of the reusable, insulated gift bag container information maintenance system 100. A reusable, insulated gift bag container information maintenance system 100 comprising a gift container 101, a computing device 102, a communication network 103, and a server 104. The reusable, insulated gift bag container information maintenance system 100 is used to maintain information regarding the transfer location of the reusable, insulated gift bag container 101 amongst multiple users. A first user purchases the reusable, insulated gift bag container 101, then the first user registers the tracking indicia of the reusable, insulated gift bag container 101 in the communication network 103 or the internet which will include the location of the reusable, insulated gift bag container 101. This information is saved within a server 104 attached to the communication network 103. The first user receives the gift 105 inside the reusable, insulated gift bag container 101 and then, on a later occasion, when the first user wants to gift a second user another gift 105, the first user packs a new gift 105 in the reusable, insulated gift bag container 101, and has the option to write a personal message in the notebook in side pocket, and then directly reuses or re-gifts the reusable, insulated gift bag container 101 to a second user, with a new gift and a new figurine. The second user receives the gift 105 from within the reusable, insulated gift bag container 101 and then the second user registers the tracking indicia of the reusable, insulated gift bag container 101 in the communication network 103 which again includes the new location of the reusable, insulated gift bag container 101. Further, the second user or recipient user will add tracking indicia onto the server 104 based on the tracking indicia as to the address of the purchaser, or where the item is being shipped by registering the unique tracking indicia, and also can write a personalized message in the notebook provided in the side pocket. Therefore, the first user will be notified of any new registrants and updates regarding the use of the reusable, insulated gift bag container 101 through the website via accessing the communication network 103 with the tracking indicia of the reusable, insulated gift bag container 101.

The reusable, insulated gift bag container 101, for example a reusable, insulated gift bag container, would make information secure and not visible to the public. Only those that register their reusable, insulated gift bag container 101 through the website can view information for a particular tracking indicia. In an example, the reusable, insulated gift bag container 101 is shipped from a warehouse with new and unique tracking indicia. The re-gifting would be part of the “game” and not be coming from a warehouse, but the previous user's location, and scanned via smart phone application, or by entering the data manually through the website on the communication network 103.

In an embodiment, the reusable, insulated gift bag container maintenance system 100 comprises attaching a complimentary and collectible adornment 106 on the gift which compliments and perfectly fits into the reusable, insulated gift bag container 101, where the gift 105 such as, but not limited to, a bottled beverage can have the optional complimentary collectible toy, plush figure or bottle stopper 106 placed on top to signify special occasions, can be transferred from the first user to the second user. In another embodiment, the method further comprises providing a pocket 107 with a notebook 108 attached to the reusable, insulated gift bag container 101, where the user enters personalized messages in the notebook 108. The first reusable, insulated gift bag container 101 purchased is shipped to the purchaser, and then subsequently will have their information pre-loaded on website, then re-gifts the reusable, insulated gift bag container 101 along the gift such as a bottled beverage topped with an optional collectible toy, plush figure or bottle stopper 106 to the next user who then registers and enters their information on the website which could contain the city, occasion, notes or pictures of the reusable, insulated gift bag container 101 and also can write a personal message in the notebook 108 located in the pocket 107, for example, the “passport” book located in the side pocket 107 of the reusable, insulated gift bag container 101 and enter information on a website through manual entry or by using a smart phone application to scan the tracking indicia or the identifying serial number. Messages and pictures can be added to the website each time the reusable, insulated gift bag container 101 is re-gifted. In an embodiment, additional seasonal or occasional stuffed figurines can also be purchased to represent birthday, anniversary, wedding, etc. to signify the event on the website or store.

In an embodiment, the users are rewarded with reward points from the communication network 103 as the reusable, insulated gift bag container 101 is transferred across each user. In an embodiment, a contest is held between the users to decide a user with the maximum number of points, where the user with the most number of points is rewarded with credits towards future purchases. Each user, through which the reusable, insulated gift bag container 101 passes, will receive points towards eligible products on the communication network 103, for example, the website, and a main contest will be shown as to the user with the most points, for example, allows users and purchasers to gain points redeemable for gifts on the website. Each person that receives the reusable, insulated gift bag container 101 will receive an email and/or text, letting the previous recipients know of its current whereabouts.

The reusable, insulated gift bag container 101 is made of, for example, a durable fabric with insulation and a handle for carrying items such as, but not limited to a bottled beverage and not meant for the outer part of a shipping package. The reusable, insulated gift bag container 101, for example, uses a heavy weight cloth material with insulation and a handle for easy carrying. The reusable, insulated gift bag container information maintenance system 100 allows the purchaser to purchase their own gift 105 and insert it into the reusable, insulated gift bag container 101 for personal gift giving purposes, not for resale. In an embodiment, the reusable, insulated gift bag container information maintenance system 100 further allows registrants to gain points for purchases, and therefore check the number of times the original gift container 101 is re-gifted. In an embodiment, the communication network 103 or the website used to store codes and places where the reusable, insulated gift bag container has been transferred will allow registrants to enter messages and pictures of events attended. In an embodiment, the reusable, insulated gift bag container information maintenance system 100 further comprises automated text and/or emails letting the previous registrants and gift givers know where the reusable, insulated gift bag container 101 has traveled next.

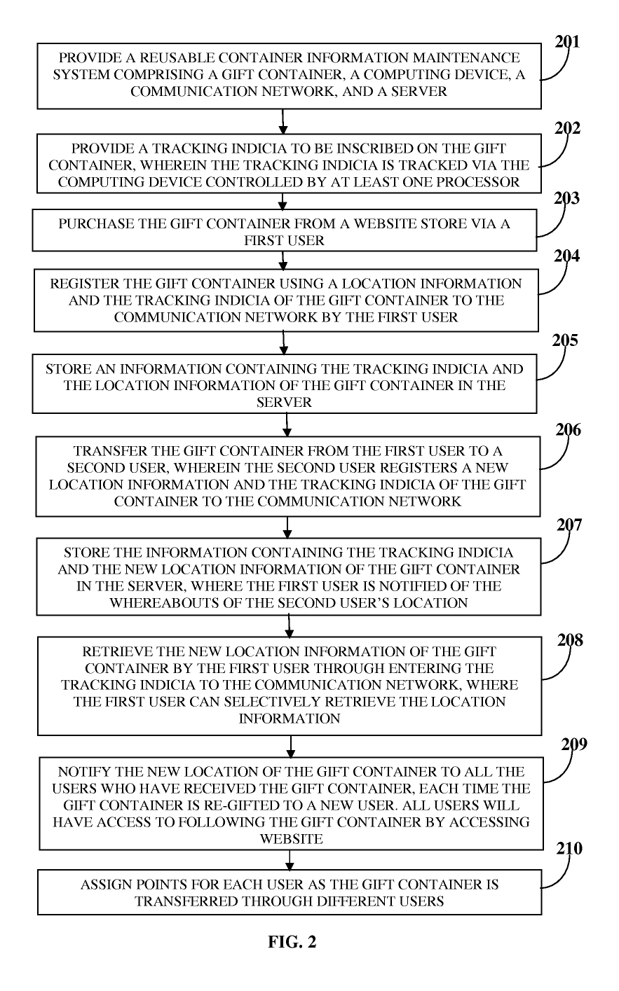

FIG. 2 exemplarily illustrates a method for maintaining information about a reusable, insulated gift bag container 101 that's transferred across multiple registrants. The method comprises providing 201 a reusable, insulated gift bag container information maintenance system 100 comprising a reusable, insulated gift bag container 101, a computing device 102, a communication network 103, and a server 104. A tracking indicia is provided 202 which is inscribed on the reusable, insulated gift bag container 101, where the tracking indicia is tracked via a computing device 102 controlled by at least one processor. The original registrant purchases 203 the reusable, insulated gift bag container 101 from a store or website and the tracking indicia will be registered 204, or the purchaser can change the registration after receipt of the reusable, insulated gift bag container 101 using a location information and the tracking indicia of the reusable, insulated gift bag container 101 to a communication network 103.

The server 104 stores 205 an information containing the tracking indicia and the location information of the reusable, insulated gift bag container 101 and also can include notes and pictures of the event of the whereabouts of the reusable, insulated gift bag container 101. The original purchaser transfers 206 the reusable, insulated gift bag container 101 to a second user, where the second user registers a new location information and the tracking indicia of the reusable, insulated gift bag container 101 to the communication network 103, and the server 104 stores 207 the information containing the tracking indicia and the new location information of the gift container 101. The second user retrieves 208 the new location information of the reusable, insulated gift bag container 101 through entering the tracking indicia to the communication network 103. The new location of the reusable, insulated gift bag container 101 is notified 209 to all the registrants who have received the reusable, insulated gift bag container 101 each time the reusable, insulated gift bag container 101 is re-gifted to a new user. All tracking information of each recipient registrant will be forwarded to the previous users that have received the same reusable, insulated gift bag container 101 with the same tracking indicia. Then points are assigned 210 for each registrant as the reusable, insulated gift bag container 101 is transferred and new owners register. All users would have access to retrieving information stored in communications network.

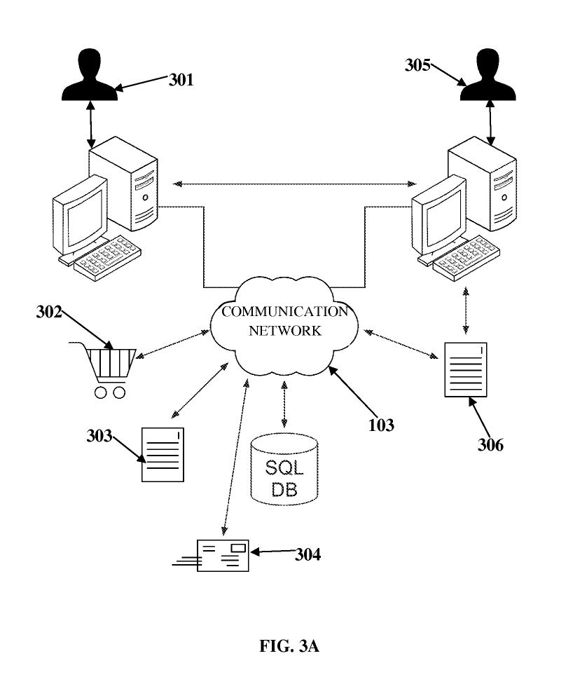

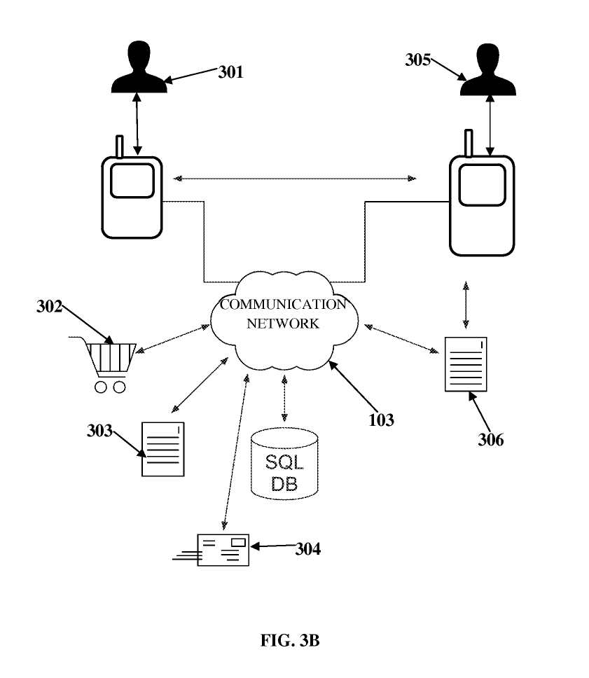

FIGS. 3A-3B exemplarily illustrate a schematic diagram showing a working example of an embodiment of the reusable, insulated gift bag container information maintenance system, in communication with personal computers (PC) or laptop, as shown in FIG. 3A, and in communication with mobile devices as shown in FIG. 3B. The original purchaser 301 visits the communication network 103, for example, the website, to purchase the reusable, insulated gift bag container 101. The reusable, insulated gift bag container 101 is added to the shopping cart 302 and the original purchaser 301 checks out after paying for the item. The information regarding the original purchaser 301 is entered into the tracking website 303, where the information comprises, for example, username, password, address, email address, and unique tracking indicia number. In an embodiment, for privacy reasons, information such as home address, phone, email, etc., are not made public to the site where users can access where the reusable, insulated gift bag container 101 has been unless they want to, therefore the personal information such as in the info needed to ship the initial purchase is kept as private. A confirmation email 304 is sent to the original purchaser 301 with login information of the tracking website 303 and the delivery information. The original purchaser 301 also can login to the tracking website 303 and add comments. Then the original purchaser 301 gifts the reusable, insulated gift bag container 101 along with a gift 105 to a second user 305, where instructions are provided on a booklet attached to the reusable, insulated gift bag container 101 which illustrates the method to register the tracking indicia on the website 303. Secondary 305 registrants can locate the registry 306 on the tracking website 303, for example, “gifted” tote as a “wino” purchaser. Therefore, now the original purchaser 301 and secondary registrants 305 are linked to the tracking website 303 via the tracking indicia. As the reusable, insulated gift bag container 101 is passed on, there is potential for new registrants to be added. All the registrants related to the unique tracking indicia number can follow the transfer or travel of the reusable, insulated gift bag container 101 and add notes and pictures to all the registrants linked within.

The reusable, insulated reusable, insulated gift bag container 101 is capable of holding a gift 105 such as, but not limited to, a bottled beverage, for example, wine bottle, etc, wherein the reusable, insulated gift bag container 101 embodies a unique tracking indicia which could be, but not limited to, a number, for example, a Quick Response Code (QR code), or a Universal Product Code (UPC bar code), where a phone application could view the identifier and track the reusable, insulated gift bag container 101, or a registrant could enter information into the tracking tool. Wherein the registrant which is accessing computer based, or a smart phone application system provides tracking indicia to track information and ownership of reusable, insulated gift bag container 101. The reusable, insulated gift bag container 101 also incorporates a specified area such as a pocket 107 to include a placement for a book or booklet for personalized messages. Optional collectible toy, plush figure or bottle stopper 106 and its collection of characters can be placed on top of gift 105 inside bag such as, but not limited to a bottled beverage.

The objective is purchase and/or receive the gift container 101, which could be a conversation piece or could be re-gifted as many times as possible to gain points in a common place such as but not limited to, a web-based application. Purchasing a reusable, insulated gift bag container 101, and re-gifting, or passing it forward as many times possible achieves collecting points. The users have the ability to identify all the locations of where the reusable, insulated gift bag container 101 has been by allowing access to the tracking tool which then the indicia is entered and information is accessed. All users for each container will receive electronic notifications of the location of the container each time it is updated of its current location and points accumulated.

Person one purchases the container and registration of the indicia is noted for the initial purchased container on the tracking device website. A personal message and/or photos can be added to the communication network 103, for example, the Internet website, with the whereabouts of the reusable, insulated gift bag container 101 subsequently by additional recipients of the gift container 101. Personalized messages can be hand noted into the notebook 108 located in the specified area of the gift container 101, and each recipient or new purchaser gives the reusable, insulated gift bag container 101 as a gift to another person. The new recipient of the reusable, insulated gift bag container 101 then goes to website and/or scans the indicia and registers the reusable, insulated gift bag container 101 with new location information. This tracking process can go through endless recipients and gift givers. The first initial person to purchase the reusable, insulated gift bag container 101 and/or collectible novelty figurines 106 will receive points for the additional purchase. Each recipient of the reusable, insulated gift bag container 101 will also receive points once the reusable, insulated gift bag container 101 is registered. The original purchaser of the gift container 101 will receive points for each time the reusable, insulated gift bag container 101 is re-gifted.

In an example, but not limited to, how a points structured system may work. During the initial purchase of container, the user earns 10 points and additional 5 points for the collectible novelty figurine 106. When the reusable, insulated gift bag container 101 is re-gifted, the recipient of the container earns 5 points and original purchaser receives 5 points each time the bag is re-gifted. No points are accumulated for re-gifting the collectible novelty figurine 106. Once a user has accumulated 100 points they will be able to use the points to purchase items off the website, where 100 points for example may be equal to 5.00 Dollars. The points may or may not expire.

In an example, reaching a goal of 1000 points will earn the user a bronze medal special edition collectible novelty figurine 106, reaching a goal of 2000 points will earn the user a silver medal special edition collectible novelty figurine 106, and reaching a goal of 3000 points will earn the user a gold medal special edition collectible novelty figurine 106. All recipients of the bronze, silver, or gold medals will be honorably mentioned on the website. There is no limit to the awards, as long as points are accumulated, and redeemed for each threshold, and the reusable, insulated gift bag container 101 may hold any gift 105 item that may fit inside the area.

The reusable, insulated gift bag container 101 has multiple characters that can fit onto a gift 105 such as, but not limited to a wine bottle. The collectible novelty figurines 106 will produce new characters, users will have the ability to sign up for a monthly club and have the option of sharing information with other users, and no users information will be shared unless the user chooses the option to share. When any information is entered into the tracking system, the user will have the ability to enter a special code name so personal information is not released. Only the users involved for each reusable, insulated gift bag container 101 will have access to the information for each individual reusable, insulated gift bag container 101.

The foregoing examples have been provided merely for the purpose of explanation and are in no way to be construed as limiting of the present concept disclosed herein. While the concept has been described with reference to various embodiments, it is understood that the words, which have been used herein, are words of description and illustration, rather than words of limitation. Further, although the concept has been described herein with reference to particular means, materials, and embodiments, the concept is not intended to be limited to the particulars disclosed herein; rather, the concept extends to all functionally equivalent structures, methods and uses, such as are within the scope of the appended claims. Those skilled in the art, having the benefit of the teachings of this specification, may affect numerous modifications thereto and changes may be made without departing from the scope and spirit of the concept in its aspects.

I claim:

1. A method for maintaining information about a reusable, insulated gift bag container that's transferred across a plurality of users, the method comprising:
providing a reusable container information maintenance system comprising a reusable, insulated gift bag container, a computing device, a communication network, and a server;
providing tracking indicia to be inscribed on the reusable, insulated gift bag container, wherein the tracking indicia is tracked via the computing device controlled by at least one processor;
purchasing the reusable, insulated gift bag container from one of an Internet website or a store via a first user;
registering the reusable, insulated gift bag container using location information and the tracking indicia of the gift container to the communication network by the first user;
storing information containing the tracking indicia and the location information of the reusable, insulated gift bag container in the server;
one of transferring and re-gifting the reusable, insulated gift bag container from the first user to a second user, wherein the second user registers a new location information and the tracking indicia of the reusable, insulated gift bag container to the communication network;
storing the information containing the tracking indicia and the new location information of the reusable, insulated gift bag container in the server;
retrieving the new location information of the reusable, insulated gift bag container by the second user through entering the tracking indicia to the communication network;
notifying the new location of the reusable, insulated gift bag container to all the users who have received the reusable, insulated gift bag container, each time the container is re-gifted to a new user; and
assigning points for each registrant user as the reusable, insulated gift bag container is transferred through different users.

2. The method of claim 1, further comprising providing a pocket with a notebook attached to the reusable, insulated gift bag container, wherein the notebook is configured to enter personalized messages by a user.

3. The method of claim 1, further comprising attaching a collectible toy, plush figure or bottle stopper on the gift within the reusable, insulated gift bag container, wherein the collectible toy, plush figure or bottle stopper and reusable, insulated gift bag container are transferred as a gift to the second user.

4. The method of claim 1, wherein the registrant users are rewarded with reward points from the communication network as new users register under the same unique tracking indicia of the reusable, insulated gift bag container.

5. The method of claim 5, wherein a contest is held between the users to decide a registrant user with the maximum number of points, wherein the registrant user with most number of points is rewarded.

6. The method of claim 5, wherein the membership points received by each registrant user during the transfer of the reusable, insulated gift bag container can be used for membership rewards through the website.
